(19) United States
(12) Patent Application Publication
(10) Pub. No.: US 2020/0223401 A1
(43) Pub. Date: Jul. 16, 2020

(54) DEVICE FOR CLEANING A CAMERA LENS AND METHOD OF USING SAME

(71) Applicant: MOTHERSON INNOVATIONS COMPANY LIMITED, London (GB)

(72) Inventor: Andrew Brian Little, Portchester (GB)

(21) Appl. No.: 16/743,725

(22) Filed: Jan. 15, 2020

(30) Foreign Application Priority Data
Jan. 16, 2019 (DE) 10 2019 101 092.6

(51) Int. Cl. B60S 1/56; B60R 11/04; B60S 1/52; H04N 5/225; B60S 1/54; B08B 3/10; B08B 5/04

(52) U.S. Cl. CPC B60S 1/56; B60R 11/04; B60S 1/52; B08B 5/04; B60S 1/54; B08B 3/102; H04N 5/22521

(57) ABSTRACT

A device for cleaning at least one optical surface of at least one camera, a camera system and a camera holder including such a device and a method of using the device, the camera system and/or the camera holder.

### CROSS-REFERENCE TO RELATED APPLICATION

This application claims the benefit of foreign priority to German Patent Application No. DE 10 2019 101 092.6, filed Jan. 16, 2019, which is hereby incorporated by reference in its entirety for all purposes.

### BACKGROUND

### 1. Field of the Invention

The present disclosure relates to a device for cleaning at least one optical surface of at least one camera, and also relates to a camera system and a camera holder including such a device and further relates to a method of using same.

### 2. Related Art

Sensors, especially optical sensors such as cameras, are widely used in modern motor vehicles. Especially for the upcoming autonomous driving an increased number of respective cameras is necessary to be incorporated in order to gather required environmental information for processing the driving commands of the vehicle. Beside that also for rear view replacement systems, respective cameras are increasingly used.

However, it is important that such cameras provide a constant high and reliably data quality. To a wide extent this issue is not only dependent on the electronic and software components of the camera and subsequent data processing but also on the circumstances under which the respective image data has been captured. In this respect it must be particularly mentioned that during use of the camera, contamination of the camera's lens due to rain, mud splashes or the like may occur. Further, also during long-term use of the camera, debris on the camera lens increases. Consequently, image data become affected as the original scene to be taken by the camera can no longer be captured without artifacts due to contamination of the lens. This, however, lead to captured camera images of reduced quality and/or to situations in which objects are masked due to contamination overlay. This in turn adversely affects image processing which is based on the captured raw data. Finally, all this might lead to dangerous situations when the driver or an image processing unit does not recognize an object such as an approaching car from behind.

### SUMMARY

In an aspect, a device for cleaning at least one optical surface of at least one camera, includes at least one supply element is adapted for providing a cleaning agent of at least one of a cleaning fluid, preferably water, to the optical surface to be cleaned, compressed air, especially in form of at least one air stream, to the optical surface to be cleaned, a negative pressure for the intake of ambient air from the optical surface to be cleaned, where the supply element includes a channel system having at least one outer opening provided in or at the supply element for providing the cleaning agent to or from the supply element and a plurality of inner openings for providing the cleaning agent to or from the optical surface to be cleaned, where the channel system is adapted to produce a vortex of cleaning fluid, compressed air or ambient air on or in the vicinity of the optical surface to be cleaned during cleaning.

In an embodiment the channel system is suitable shaped to produce a clockwise or anti-clockwise rotating vortex over the optical surface to be cleaned.

In an embodiment the supply element has a hollow inner area surrounding at least a part of the optical surface to be cleaned with a surrounding side including the plurality of inner opening, preferably the inner openings are arranged circumferential and/or equidistant in the surrounding side.

In an embodiment the channel system includes a first channel assembly circumferential to the surrounding side having a plurality of separate junctions with one of the junctions being connected to the at least one outer opening and the other junctions each being connected to one of the inner openings via separate second channel assemblies suitably aligned within the supply element to produce the vortex.

In an embodiment the first channel assembly is arranged as a ring around the surrounding side and the junctions are suitable arranged, preferably symmetrically, along the ring.

In an embodiment the second channel assemblies are arrange symmetrically to each other between the junctions and the inner openings in a non-radial direction with respect to a center of the vortex.

In an embodiment the second channel assemblies are arranged spiral-like between the junctions and the inner openings to create the stale rotating vortex.

In an embodiment the second channel assemblies are aligned at least in the vicinity of the inner openings in an angle of 5 to 60 degree, preferably of 10 to 45 degree, more preferably of 20 to 30 degree, most preferably of 25 degree, with respect to a cross sectional plane through the supply element on half height of the surrounding side in order to produce an downward or upward jet of cleaning fluid, compressed air or ambient air through the inner openings.

In an embodiment the channel system includes second and/or a third first channel assembly, where each of the first channel assemblies are connected via separate second channel assemblies to separate inner openings.

In an embodiment the device is designed such as being suitable to be mounted on the camera, preferably to be mounted on top of the optical surface to be cleaned, preferably the supply element is adapted to receive at least one portion of the optical surface to be cleaned.

In an embodiment the outer opening in connected to a nozzle for connecting a supply channel for the cleaning agent.

In an embodiment the device is designed to create a negative pressure when operated mobile, especially at least in the vicinity of the optical surface to be cleaned lens and/or at least in the vicinity of at least one of the outlets.

In an embodiment the device further includes two or more supply elements arranged on top of each other.

In an embodiment the two or more supply elements can be operated separately with separate outer openings or can be operated jointly with one joint outer opening connected to the first channel assemblies of the two or more supply elements.

In an embodiment one of the supply elements provide the clockwise rotating vortex and the adjacent other supply element provide the anti-clockwise rotating vortex.

In an embodiment the device includes two supply elements, where one of the supply elements as a first supply element is arranged for providing the cleaning fluid and/or the compressed air and the other supply element as a second supply element on top of the first supply element is arranged for providing a negative pressure in the vicinity of the optical surface to be cleaned for removing the cleaning fluid, the compressed air and/or contaminations from the optical surface to be cleaned.

In an embodiment the two or more supply elements include connecting means, preferably connecting holes, for connecting the supply elements to each other, and fastening means, especially screws and/or rivets, mating appropriately together with the connecting means.

In an embodiment the two or more supply elements are designed as one common element.

In another aspect, a camera system includes at least one camera, preferably having a lens, and the at least one device for cleaning.

In an embodiment of the camera system the device is mounted on the optical surface to be cleaned of the camera and/or that the device receives, especially in at least one portion, the optical surface to be cleaned, preferably the optical surface to be cleaned is a lens of the camera.

In another aspect, a camera holder includes at least one holding structure and the at least one device for cleaning, preferably connected to and/or integrally formed with the holding structure.

In an embodiment, the camera holder and the holding structure includes at least in areas at least one, preferably two or three, supply channel(s), preferably being internally molded with the holding structure, for supplying cleaning fluid, for supplying compressed air and/or for providing negative pressure at the outer opening of the device.

In another aspect, a method of using the device, the camera system and/or the camera holder includes applying cleaning fluid to at least one optical surface to be cleaned of at least one camera, especially by providing a flow of cleaning fluid out of the inner openings; and/or applying compressed air to the optical surface to be cleaned of the camera, especially by providing a flow of compressed air out of the inner openings; and removing at least parts of the cleaning fluid and contamination particles from the optical surface to be cleaned of the camera, especially by providing negative pressure at the inner openings, preferably by establishing a suction flow of ambient air at the inner openings.

In an embodiment of the method the respective steps are carried out in response that in the step of determining the degree of contamination of at least one portion of the optical surface it is determined that the degree of contamination exceeds a, preferably predefined, threshold value.

It has, thus, been found that the quality of image data captured by a sensor such as a camera can be increased by a device for cleaning a camera lens which includes at least one supply element for applying at least one cleaning agent to the optical surface of the camera, e.g. the lens, wherein in order to achieve this a channel system is included by the first element. This channel system particularly allows to supply the respective cleaning agent. Furthermore, in order to increase the cleaning capability of the device, the device provide first and second channel assemblies arranged in a particular way or provide more than one supply elements. The additional supply elements and/or second channel assembly allows for providing at least one air stream directed to the optical surface to be cleaned, e.g. the lens. The inventors have in this respect realized that the air stream in conjunction with the cleaning fluid provides an increased cleaning efficiency of the optical surface to be cleaned since the air stream leads to an increased interaction between the optical surface to be cleaned, hence the contamination, on the one hand and the cleaning fluid on the other hand. Further, the device might alternatively or in addition also provide a third supply element. The second or third element allows providing a negative pressure in the vicinity of the lens for removing cleaning fluid and/or contaminations. Applying such a negative pressure, i.e. vacuum, leads to superb cleaning results since it can be avoided that solved contaminations adhere again to the optical surface to be cleaned. Instead, according to an example, due to the negative pressure the contamination is sucked along with the cleaning fluid away.

This setup allows that the device can be built up with different individual first, second and/or third supply elements, each having an individual purpose, hence one individual channel assemblies. Or alternatively that at least one supply element has at least two purposes, hence at least two individual channel systems. In another example, it has been found advantageously that for one single supply element having at least two purposes the respective two channel assemblies are designed as one common channel assembly, either entirely or at least in sections. By doing so, to a great extend or entirely one single supply channel can be used for more than one purpose, e.g. providing the compressed air as well as providing the negative pressure. In every case, this lead to a simplification of the design of the device, hence, a reduction in size and in manufacturing costs. In another example, one or more elements might be designed as one common element which might also reduce the size and manufacturing cost.

It might be possible that a first of the supply elements is arranged for applying compressed air and/or for providing under pressure (i.e. negative pressure) in the vicinity of the optical surface. The first supply element might be adapted to provide at least one of cleaning fluid, compressed air and negative pressure exclusively or sequentially on demand. The same holds for the second and third supply elements, if present.

Preferably nozzles can be part of the individual elements, for example, they are integrally formed with the respective supply element, which can be connected or connectable to the outer opening as an inlet (hence, nozzles) and/or the inner openings (hence, nozzles) and which in turn allows an improved forming of the outgoing fluid jet or allows in an convenient manner to connect further supply assemblies to the nozzles, hence the channel assemblies.

Preferably the channel assemblies are completely or at least in sections internally molded within the respective elements. This allows to design an integral element, hence, reducing costs and size of the device.

For example, if the channel system includes at least one first channel assembly and a plurality of second channel assemblies, the first channel assembly might serve to feed the second channel assemblies. Hence, designs of the channel system might be chosen especially by means of one circumferential first channel assembly which feeds a plurality of second channel assemblies which is easy to manufacture and provides a clear design. The second channel assemblies in turn might be non-radially arranged in at least one cross-sectional plane such as a horizontally cross-sectional plane of the respective element. It has been proven advantageous that optional the second channel assemblies extend inclined with respect to the radial orientation in order to produce a direction of force clockwise or anti-clockwise for the jet stream of cleaning fluid or air. Likewise, sloping the extension of the second channel assemblies, relative to the horizontally cross-sectional plane allows to produce a direction of force for a downward jet direction.

The inventors have further realized that preferably a hollow cylindrical shape of the first, second, or third supply elements allows a convenient and appropriate receiving of the optical surface to be cleaned. In other words, the optical surface can be arranged at least partly within the inner space of the hollow cylindrical shape of one or more supply elements. Further, an efficient arrangement of the inner openings and possibly respective nozzles of the individual elements or of the individual channel assemblies might be achieved using the inner surface of the hollow cylindrical shape.

If a camera holder is provided, it has proven advantageous that the camera holder includes an inventive device and in addition also includes supply channels in the holding structure. This allows to connect the respective channel assemblies of the device and the supply channels with each other so that cleaning fluid, compressed air and/or negative pressure can be directly supplied to the device. This represents a quite compact design.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the invention.

FIG. 1 shows a top view of an example of the device.

FIG. 2 shows a schematic perspective cut view of the device of FIG. 1.

FIG. 3 shows a schematic cut view of the device of FIG. 1.

FIG. 4 shows a side view of another embodiment of the device and the camera system.

FIG. 5 shows a schematic view of an embodiment of the camera holder.

FIG. 6 shows an example of a method of using the device.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

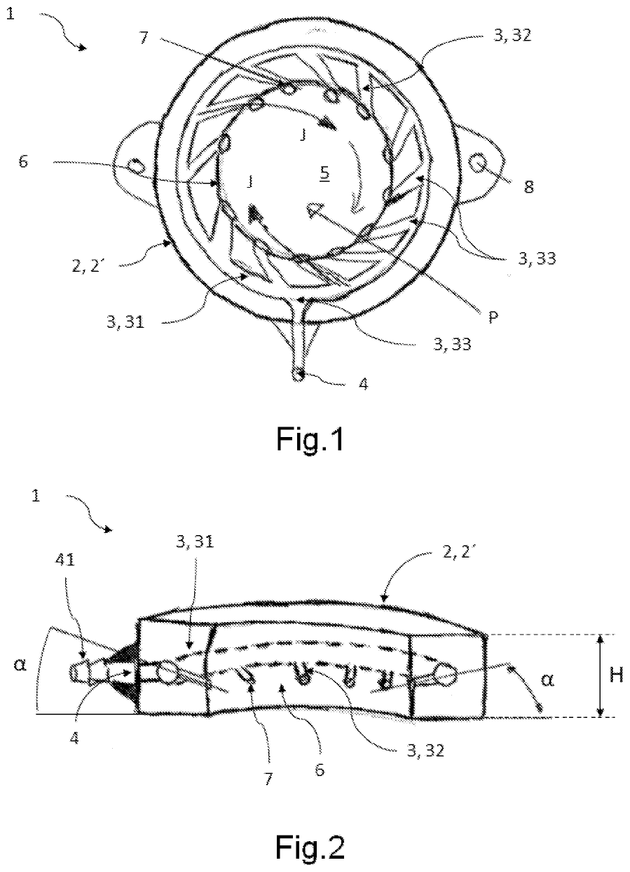

FIG. 1 shows a top view of an embodiment of the device 1 according to an example including at least one supply element 2, 2′ is adapted for providing a cleaning agent of at least one of a cleaning fluid, preferably water, to the optical surface 103 to be cleaned, compressed air, especially in form of at least one air stream, to the optical surface 103 to be cleaned, and/or a negative pressure for the intake of ambient air from the optical surface 103 to be cleaned. The supply element 2, 2′ includes a channel system 3 having at least one outer opening 4 provided in and/or at the supply element 2, 2′ for providing the cleaning agent to or from the supply element 2, 2′ and a plurality of inner openings 7, preferably shaped as nozzles, for providing the cleaning agent to or from the optical surface 103 to be cleaned, where the channel system 3 is adapted to produce a vortex P of cleaning fluid, compressed air or ambient air on or in the vicinity of the optical surface 103 to be cleaned during cleaning. The channel system 3 is suitably shaped to produce a clockwise or anti-clockwise rotating vortex P over the optical surface 103 to be cleaned. The supply element 2, 2′ has a hollow inner area 5 surrounding at least a part of the optical surface 103 to be cleaned with a surrounding side 6 including the plurality of inner opening 7, where the inner openings 7 are arranged circumferential and/or equidistant in the surrounding side 6. The channel system 3 includes a first channel assembly 31 circumferential to the surrounding side 6 having a plurality of separate junctions 33 with one of the junctions 33 being connected to the at least one outer opening 4 and the other junctions 33 each being connected to one of the inner openings 7 via separate second channel assemblies 32 suitably aligned within the supply element 2, 2′ to produce the vortex P. Here, the first channel assembly 31 is arranged as a ring around the surrounding side 6 and the junctions 33 are suitable arranged symmetrically along the ring 31. The second channel assemblies 32 are arrange symmetrically to each other between the junctions 33 and the inner openings 7 and spiral-like with respect to a center of the vortex (P) to create the stale rotating vortex P. The jet J of cleaning fluid or compressed air creating the vortex P are indicated. The device 1 furthermore includes connecting means 8 to be fastened to a holder.

FIG. 2 shows a schematic perspective cut view of the device of FIG. 1, where the second channel assemblies 32 are aligned in an angle of 5 to 60 degree, preferably of 10 to 45 degree, more preferably of 20 to 30 degree, most preferably of 25 degree, with respect to a cross sectional plane through the supply element 2, 2′ on half height H of the surrounding side 6 in order to produce an downward or upward jet of cleaning fluid, compressed air or ambient air through the inner openings 7. For example, the height H of the supply element 2, 2′ might be 10 mm or less, preferably 3 mm or less. Due to the slope extension of the second channel assemblies 32 a downward jet direction of the cleaning fluid is produced when leaving the inner openings 7. This particularly increases the cleaning efficiency of the device 1, since the cleaning fluid leaves the device 1 properly in the direction of the surface 103 to be cleaned. The channel system 3 may also include second and/or a third first channel assembly 31 (not shown here), where each of the first channel assemblies 31 are connected via separate second channel assemblies 32 to separate inner openings 7. Here, the outer opening in connected to a nozzle 41 for connecting a supply channel 209, 209′ for the cleaning agent. Device 1, thus, allows to apply a cleaning fluid to the inlet nozzle 4, which is then distributed through the channel system 3 to the inner openings 7 where the cleaning fluid leaves the supply element 2, 2′ and device 1, especially in the direction of the surface 103 to be cleaned, e.g. the lens of a camera, as indicated by the respective arrows J in the hollow inner area 5 in FIG. 1. Alternatively or in addition, device 1 allows to apply compressed air and/or to provide negative pressure. The supply element 2, 2′ also includes an inlet nozzle 41 which is connected to the outer opening 4. The supply element 2, 2′ and the inlet nozzle 4 are integrally formed together. Especially, the inlet nozzle 4 can be efficiently produced during manufacture of the supply element 2, 2′ since the inlet nozzle 4 becomes a channel in the main mold.

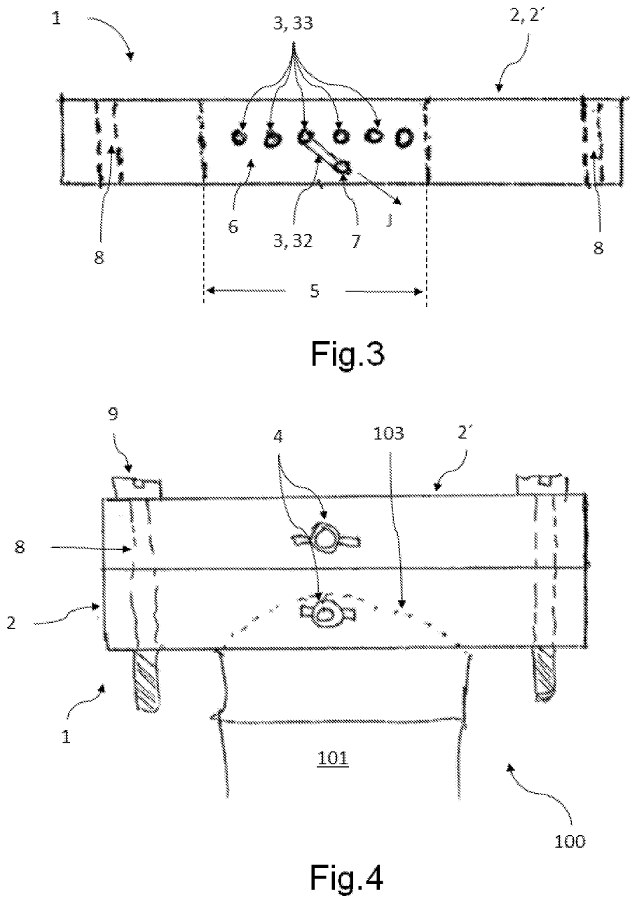

FIG. 3 shows another schematic cut view of the device 1 of FIG. 1, where the declining second channel assemblies 32 are arranged spiral-like between the junctions 33 and the inner openings 7 to create the stale rotating vortex P.

FIG. 4 shows a side view of another embodiment of the device 1 and the camera system 100 according to the present disclosure, where the device 1 is mounted on the camera 101 on top of the optical surface 103 to be cleaned to form a camera system 100. The supply element 2, 2′ is adapted to receive at least one portion of the optical surface 103 to be cleaned. The device 1 further includes two supply elements 2, 2′ arranged on top of each other, which can be operated separately via separate outer openings 4. One of the supply elements 2 provide the clockwise rotating vortex P′ and the adjacent other supply element 2′ provide the anti-clockwise rotating vortex P′. One of the supply elements 2, 2′ as a first supply element 2 is arranged for providing the cleaning fluid and/or the compressed air and the other supply element 2′ as a second supply element 2′ on top of the first supply element 2 is arranged for providing a negative pressure in the vicinity of the optical surface 103 to be cleaned for removing the cleaning fluid, the compressed air and/or contaminations from the optical surface 103 to be cleaned. The two supply elements 2, 2′ include connecting means 8, here connecting holes, for connecting the supply elements 2, 2′ to each other, and fastening means 9, here screws, mating appropriately together with the connecting means 8. In another example, the two supply elements 2, 2′ might be designed as one common element.

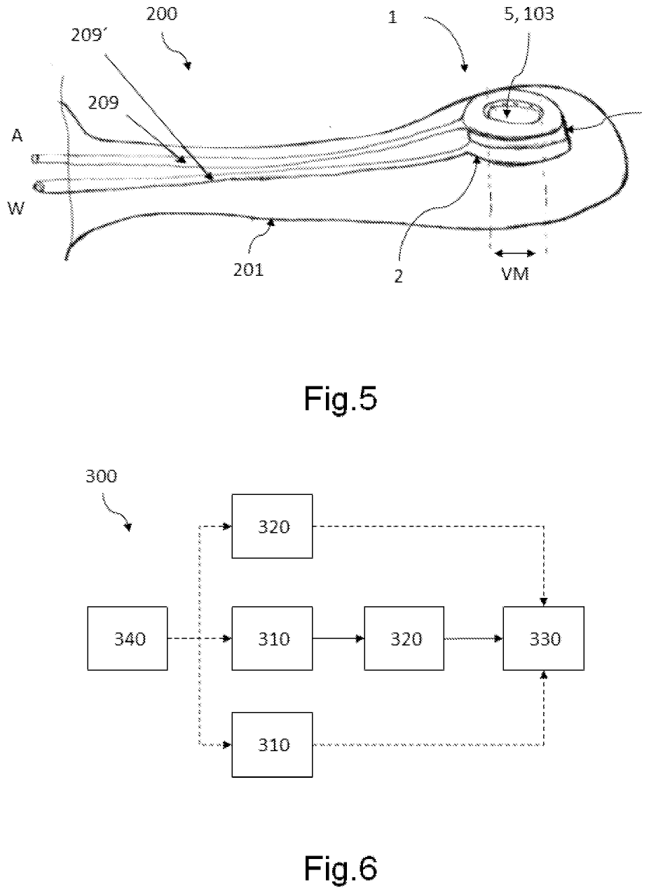

FIG. 5 shows a schematic view of an embodiment of the camera holder 200 according to an example. The camera holder 200 includes a holding structure 201 and a device 1 connected to the holding structure 201. The device 1 includes a first supply element 2 for applying cleaning fluid to a surface 103 to be cleaned. The first supply element 2 can be for example designed such as the supply element 2 as described above with respect to FIGS. 1 to 3. Device 1 further includes a second supply element 2′ for providing compressed air, especially in form of at least one air stream, directed to the surface 103 to be cleaned. The second supply element 2 might be designed similar or even identical to the first supply element 2. The holding structure 201 includes two supply channels 209, 209′ for supplying, respectively, cleaning fluid W and compressed air A to, respectively, the first and second supply elements 2, 2′ via first and second inlet nozzles (not shown in detail in FIG. 5). The supply channels 209, 209′ preferably are internally molded with the holding structure 201. Applying cleaning fluid W via the first supply channel 209′ to the first supply element 2, hence, lead to application of cleaning fluid to the surface to be cleaned 103, e.g. the lens of the camera 101. Applying compressed air A via the supply channel 209′ to the second supply element 2′, hence, lead to application of compressed air to the lens. The surface to be cleaned 103 in turn can be received in the hollow inner area 5 of the first and second supply elements 2, 2′. Of course, optionally a third supply element for providing negative pressure in the vicinity of the lens can also be provided in conjunction with a respective first and second supply elements the device 1. With negative pressure, the cleaning fluid along with contaminations can be removed in an efficient way from the surface 103 to be cleaned. It might also be possible alternatively or in addition to use compressed air and negative pressure interchangeable with just one single element and/or just one single supply channel. Also a vacuum VM can be created when mobile. Alternatively or in addition it might be preferred to employ a design and/or shape of the device and/or the elements which lead to a negative pressure when mobile at least in the vicinity of the lens and/or in the vicinity of the outlets provided in and/or at the elements. This in turn might be used to passively allow cleaning fluid and/or compressed air to leave the device 1 through the respective outlets.

FIG. 6 shows an embodiment the method 300 including the steps of applying 310 cleaning fluid to at least one optical surface to be cleaned 103 of at least one camera 101, especially by providing a flow of cleaning fluid out of the inner openings 7; and/or applying 320 compressed air to the optical surface 103 to be cleaned of the camera 101, especially by providing a flow of compressed air out of the inner openings 7; and removing 330 at least parts of the cleaning fluid and contamination particles from the optical surface 103 to be cleaned of the camera 101, especially by providing negative pressure at the inner openings 7, preferably by establishing a suction flow of ambient air at the inner openings 7. The respective steps are carried out in response that in the step of determining the degree of contamination of at least one portion of the optical surface 103 it is determined that the degree of contamination exceeds a, preferably predefined, threshold value.

The features disclosed in the claims, the specification, and the drawings maybe essential for different embodiments of the claimed invention, both separately or in any combination with each other.

### REFERENCE SIGNS

1 Device
2 (First) supply element
2′ (Second) supply element
3 Channel system
31 First channel assembly
32 Second channel assembly
33 Junction between first and second channel assemblies or the inlet
4 Outer opening
41 Nozzle
5 Hollow inner area
6 Surrounding side
7 Inner openings
8 Connecting means
9 Fastening means
100 Camera system
101 Camera
103 Surface to be cleaned, e.g. a camera lens
200 Camera holder
201 Holding structure
209, 209′ Supply channel
300 Method
310 Applying cleaning fluid to at least one optical surface to be cleaned
320 Applying compressed air to the optical surface to be cleaned
330 Removing at least parts of the cleaning fluid and contamination particles from the optical surface to be cleaned
340 determining the degree of contamination of at least one portion of the optical surface
A Ambient air, compressed air
H Height
J jet of cleaning fluid or compressed air
P Vortex
VM Vacuum when being mobile
Cleaning fluid
α Angle

What is claimed is:

1. A device for cleaning at least one optical surface of at least one camera, the device comprising
at least one supply element adapted for providing a cleaning agent of at least one of
a cleaning fluid or water to the optical surface to be cleaned,
compressed air comprising at least one air stream to the optical surface to be cleaned,
a negative pressure for intake of ambient air from the optical surface to be cleaned,
wherein the supply element comprises a channel system having at least one outer opening provided in or at the supply element for providing the cleaning agent to or from the supply element and a plurality of inner openings, shaped as nozzles, for providing the cleaning agent to or from the optical surface to be cleaned,
wherein the channel system is adapted to produce a vortex of cleaning fluid, compressed air or ambient air on or in the vicinity of the optical surface during cleaning.

2. The device according to claim 1, wherein the channel system is suitably shaped to produce a clockwise or anti-clockwise rotating vortex over the optical surface to be cleaned.

3. The device according to claim 1, wherein the supply element has a hollow inner area surrounding at least a part of the optical surface to be cleaned with a surrounding side comprising the plurality of inner opening, the inner openings being arranged at least one of circumferential or equidistant in the surrounding side.

4. The device according to claim 3, wherein the channel system comprises a first channel assembly circumferential to the surrounding side having a plurality of separate junctions with one of the junctions being connected to the at least one outer opening and the other junctions each being connected to one of the inner openings via separate second channel assemblies suitably aligned within the supply element to produce the vortex.

5. The device according to claim 4, wherein the first channel assembly is arranged as a ring around the surrounding side and the junctions are suitably arranged symmetrically along the ring.

6. The device according to claim 4, wherein the second channel assemblies are arranged symmetrically to each other between the junctions and the inner openings in a non-radial direction with respect to a center of the vortex.

7. The device according to claim 6, wherein the second channel assemblies are arranged spiral-like between the junctions and the inner openings to create the stale rotating vortex.

8. The device according to claim 4, wherein the second channel assemblies are aligned at least in the vicinity of the inner openings in an angle of 5 to 60 degree, 10 to 45 degree, 20 to 30 degree, or 25 degree, with respect to a cross sectional plane through the supply element on half height of the surrounding side in order to produce a downward or upward jet of cleaning fluid, compressed air or ambient air through the inner openings.

9. The device according to claim 1, wherein the channel system comprises a second or a third first channel assembly where each of the first channel assemblies are connected via separate second channel assemblies to separate inner openings.

10. The device according to claim 1, wherein the device is designed such as being suitable to be mounted on the camera, on top of the optical surface to be cleaned, the supply element being adapted to receive at least one portion of the optical surface to be cleaned.

11. The device according to claim 1, wherein the outer opening in connected to a nozzle for connecting a supply channel for the cleaning agent.

12. The device according to claim 1, wherein the device is designed to create a negative pressure when operated mobile, at least in one or more of a vicinity of the optical surface to be cleaned or a vicinity of at least one of the outlets.

13. The device according to claim 1, wherein the device further comprises two or more supply elements arranged on top of each other.

14. The device according to claim 13, wherein the two or more supply elements can be operated separately with separate outer openings or can be operated jointly with one joint outer opening connected to the first channel assemblies of the two or more supply elements.

15. The device according to claim 13, wherein one of the supply elements provides a clockwise rotating vortex and an adjacent other supply element provides an anti-clockwise rotating vortex.

16. The device according to claim 13, wherein the device comprises two supply elements, one of the supply elements is a first supply element arranged for providing at least one of the cleaning fluid or the compressed air, and the other supply element is a second supply element on top of the first supply element arranged for providing a negative pressure in the vicinity of the optical surface to be cleaned for removing at least one of the cleaning fluid, the compressed air or contaminations from the optical surface to be cleaned.

17. The device according to claim 13, wherein the at least one supply element comprises two or more supply elements, and the two or more supply elements comprise connecting means or connecting holes for connecting the supply elements to each other, and fastening means, screws or rivets, mating appropriately together with the connecting means.

18. The device according to claim 1, wherein the at least one supply element comprises two or more supply elements, and the two or more supply elements are designed as one common element.

19. A camera system comprising at least one camera and at least one device according to claim 1.

20. The camera system of claim 19, wherein the device is mounted on the optical surface of the camera to be cleaned or the device receives, in at least one portion, the optical surface to be cleaned, and the optical surface to be cleaned is a lens of the camera.

21. A camera holder, comprising
at least one holding structure; and
at least one device according to claim 1, wherein the at least one device is connected to or integrally formed with the holding structure.

22. The camera holder according to claim 21, wherein the holding structure comprises at least in areas at least one, two or three, supply channel, being internally molded with the holding structure for supplying cleaning fluid, supplying compressed air, or providing negative pressure at the outer opening of the device.

23. A method for using the device according to claim 1, comprising:
at least one of
applying cleaning fluid to at least one optical surface to be cleaned of at least one camera by providing a flow of cleaning fluid out of the inner openings; or
applying compressed air to the optical surface to be cleaned of the camera by providing a flow of compressed air out of the inner openings; and
removing at least parts of the cleaning fluid and contamination particles from the optical surface of the camera to be cleaned by providing negative pressure at the inner openings and establishing a suction flow of ambient air at the inner openings.

24. The method of claim 23, wherein the method is carried out in response to determining that a degree of contamination of at least one portion of the optical surface exceeds a predefined threshold value.
